(19) United States
(12) Patent Application Publication
(10) Pub. No.: US 2010/0177014 A1
(43) Pub. Date: Jul. 15, 2010

(54) STRUCTURE OF A SQUARE QUADRIFILAR HELICAL ANTENNA

(75) Inventors: Sang Bo Min, Seoul (KR); Jong Won Yu, Daejeon (KR); Moon Que Lee, Seoul (KR)

Correspondence Address: LRK Patent Law Firm, 1952 Gallows Rd, Suite 200, Vienna, VA, 22182, US

(73) Assignee: ACTENNA CO., LTD., Seoul (KR)

(21) Appl. No.: 12/530,684

(22) PCT Filed: Mar. 12, 2008
(86) PCT No.: PCT/KR08/01404

§ 371 Date: Feb. 9, 2010

(30) Foreign Application Priority Data
Mar. 13, 2007 (KR) 10-2007-24502

(51) Int. Cl. H01Q 1/36; H01Q 11/08

(52) U.S. Cl. 343/895

(57) ABSTRACT

Disclosed herein is the structure of a Square Quadrifilar Helical antenna (S-QHA). The structure of the S-QHA includes a square column, four radiation elements, and a feed network. The four radiation elements are formed on the square column. The feed network is disposed at the top or bottom of the square column, and feeds signals to the radiation elements at a phase difference of 90 degrees in a clockwise or counterclockwise direction. As a result, the S-QHA according to the present invention can receive circularly polarized signals.

### TECHNICAL FIELD

The present invention relates, in general, to the structure of a Quadrifilar Helical Antenna (QHA), which is used for satellite communication in a portable wireless communication device, and, more particularly, to the structure of a Square Quadrifilar Helical Antenna (S-QHA), in which helical radiation elements are formed on a square column, a feed network is provided at the top or bottom of the square column and supplies signals having a phase difference of 90 degrees to the radiation elements, and an impedance-matching circuit, by which the helical radiation elements are short-circuited to the ground of the feed network, is provided, thus being suitable for the reception of circularly polarized signals.

### BACKGROUND ART

Generally, in order for an antenna to receive high-quality service from a satellite, many requirements, including high-quality circular polarization characteristics, a wide beam width, a high front-back (F/B) ratio, and the minimization of a change in performance depending on the locations and shapes of a ground and a terminal, must be met.

Satellite receiving antennas that are widely used because they meet such requirements relatively well include QHAs. A QHA was first introduced by C. C. Kilgus in IEEE “Resonant Quadrifilar Helix,” vol. AP-17, May, 1969, pp. 349˜351.

Each of prior art QHAs is configured such that four radiation elements are implemented in the form of a circular cylinder, as shown in FIGS. 1 and 2. In order to support the radiation elements and reduce the size of the QHA, a dielectric-loaded solid circular cylinder or a dielectric-loaded hollow circular cylinder is used.

The QHA of FIG. 1 has a structure that is disclosed in U.S. Patent Publication No. 2006/0022891, and includes filar windings 12, 14, 16 and 18 that extend from the bottom region 20 to the top region 22 of a cylindrically-shaped QHA 10. The filar windings 12 and 16, arranged at opposite positions, are electrically connected to each other through a conductive bridge 23, and the filar windings 14 and 18 are electrically connected to each other through a conductive bridge 24. A signal propagating through the filar winding 12 or 16 has a perpendicular phase relationship with a signal propagating through the filar winding 14 or 18 so as to realize desired polarization. The filar windings 12, 14, 16 and 18 include respective conductive elements, such as conducting wires having a circular or square cross-section or electrical wires having conductive strings or lines on a dielectric. The conductive bridges are used along with a QHA having a filar length corresponding to an even multiple of ¼ of the wavelength at operating frequencies, but they are not generally used along with a QHA having a filar length corresponding to an odd multiple of the ¼ wavelength. The conductive bridges 23 and 24 (also referred to as “crossbars”) include respective conductive tape strips.

FIG. 2 shows the structure of a QHA that is disclosed in U.S. Publication No. 2005/0115056.

However, in order to apply such QHAs to portable terminals, small-sized QHA antennas are required, in which case the problems of the small-sized antennas are reduction in the radiation pattern, the radiation efficiency, the axial ratio and the antenna gain.

### DISCLOSURE OF INVENTION

### Technical Problem

Accordingly, the present invention has been made keeping in mind the above problems occurring in the prior art, and an object of the present invention is to provide the structure of an S-QHA, in which helical radiation elements are formed on a dielectric-loaded solid square column, a dielectric-loaded hollow square column or a square PCB, thereby facilitating the manufacture of an QHA.

Furthermore, another object of the present invention is to provide an antenna module that can be easily implemented and can be formed in various shapes because an antenna unit and a feed network are separate from each other.

### Technical Solution

In order to accomplish the above objects, the present invention provides the structure of a Square Quadrifilar Helical antenna (S-QHA), including a square column; four radiation elements formed on the square column; and a feed network disposed at the top or bottom of the square column and configured to feed signals to the radiation elements at a phase difference of 90 degrees in a clockwise or counterclockwise direction.

Preferably, the structure of the S-QHA further includes a low-noise amplification unit connected to the radiation elements and configured to amplify received signals in a low-noise manner.

The structure of the S-QHA may further include an impedance-matching circuit, an end of which is grounded to short-circuit points of the feed network and a second end of which is electrically connected to the radiation elements.

Furthermore, it is preferred that the feed network be formed of a Low Temperature Co-fired Ceramic (LTCC) or a multilayer Printed Circuit Board (PCB).

Preferably, the square column uses one or more of air, dielectric, ceramic, and a PCB board as media, has a square cross-section, and has a hollow or solid form, the hollow form being symmetrical with respect to a vertical line.

### Advantageous Effects

The structure of an S-QHA according to the present invention can be easily manufactured and the operating frequency thereof can be easily varied because radiation elements are formed on a square column.

### BRIEF DESCRIPTION OF THE DRAWINGS

FIG. 1 is a diagram showing the structure of a prior art QHA having a hollow circular cylindrical dielectric;

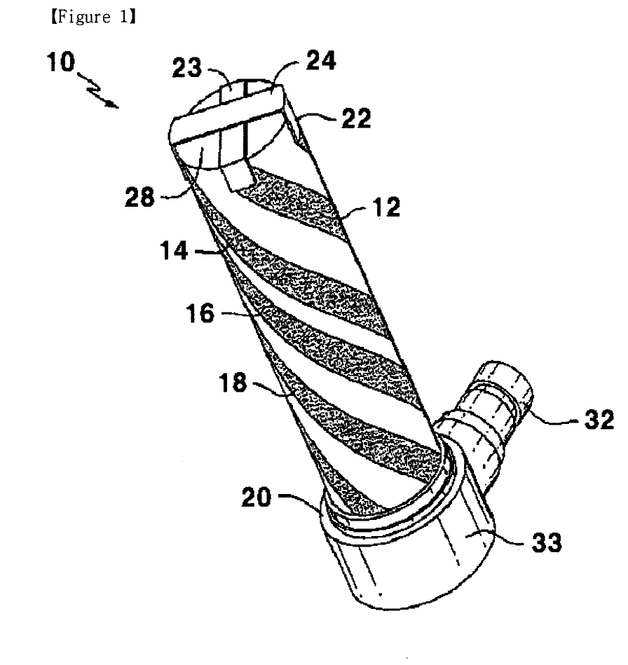

FIG. 2 is a diagram showing the structure of a prior art QHA having a solid circular cylindrical dielectric;

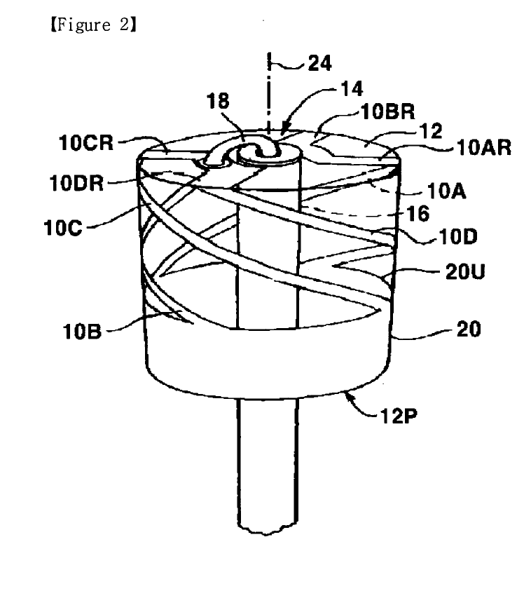

FIG. 3 is a diagram showing the structure of a ¼ wavelength S-QHA according to an embodiment of the present invention;

FIG. 4 is a diagram showing the structure of a ¼ wavelength S-QHA having an impedance-matching circuit according to another embodiment of the present invention;

FIG. 5 is a diagram showing the construction of the S-QHA based on FIGS. 3 and 4;

FIG. 6 is an assembly diagram showing the S-QHA antenna using a PCB based on FIGS. 3 and 4;

FIG. 7 is a diagram showing various forms of the square columns based on FIGS. 3 and 4;

FIG. 8 is a diagram showing various structures in which the antenna modules based on FIGS. 3 and 4 are combined with low-noise amplifiers;

FIG. 9 is a diagram showing the structures of various radiation elements based on FIGS. 3 and 4;

FIG. 10 is a diagram showing simulation results for an S-QHA having Right Handed Circular Polarization (RHCP) based on in FIGS. 3 and 4; and

FIG. 11 is a diagram showing simulation results for an S-QHA having Left Handed Circular Polarization (LHCP) based on in FIGS. 3 and 4.

### DESCRIPTION OF REFERENCE NUMERALS OF PRINCIPAL ELEMENTS IN THE DRAWINGS

31, 41 and 51: square column

32 and 42: radiation element

33 and 43: impedance-matching circuit

35 and 45: housing

37 and 47: feed network

39 and 49: low-noise amplification unit

44: feeding point

46: short-circuit point

58A˜58D: coupling protrusions and recessions

### MODE FOR THE INVENTION

A satellite communication antenna module for receiving satellite signals in a portable wireless device according to an embodiment of the present invention will be described in detail below with reference to the accompanying drawings.

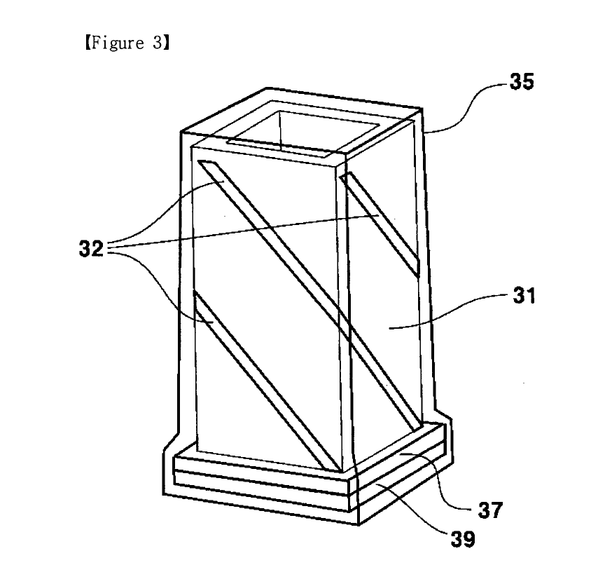

As shown in FIG. 3, the present invention includes a square column 31; four radiation elements 32 formed on the square column 31; and a feed network 37 disposed at the top or bottom of the square column 31 and configured to feed signals to the radiation elements 32 at a phase difference of 90 degrees in a clockwise or counter-clockwise direction.

Furthermore, the ¼ wavelength S-QHA antenna according to one embodiment of the present invention is connected to the radiation elements 32, and further includes a low-noise amplification unit 39 for amplifying received signals in a low-noise manner.

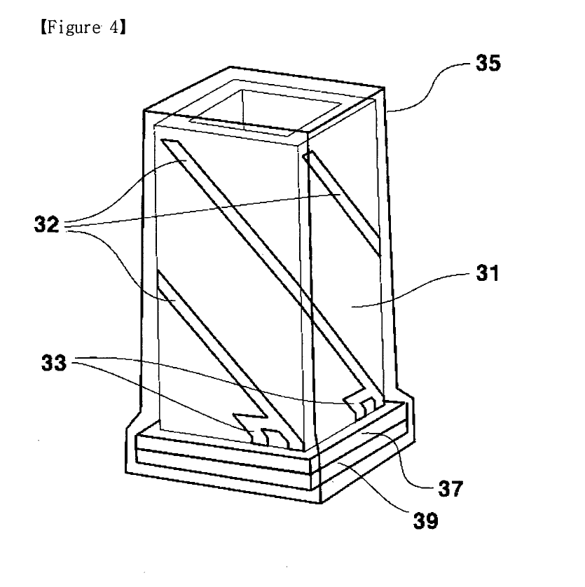

Furthermore, as shown in FIG. 4, the present invention further includes an impedance-matching circuit 33 in which respective radiation elements 32 are short-circuited to the ground of the feed network 37.

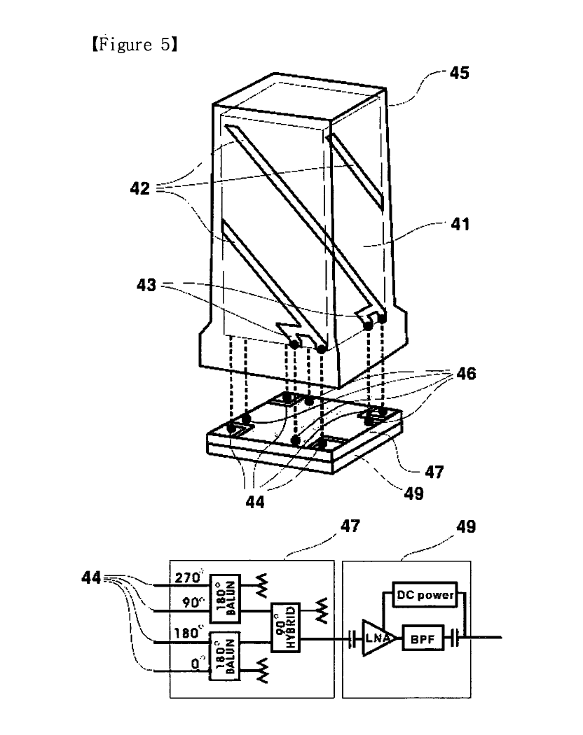

As shown in FIG. 5, each of the impedance-matching circuits 33 and 43 is configured such that one end thereof is grounded to the short-circuit points 46 of a feed network and the other end thereof is electrically connected to radiation elements 32 or 42.

The radiation elements 32 and 42, open at one end of an antenna for a portable device, constitute the structures of the QHAs having a length corresponding to about ¼ of the wavelength of the transmission frequency. The feed networks 37 and 47 are disposed at respective bottoms of the square columns 31 and 41.

The structure of the S-QHA according to the present invention includes a square column 31, 41 or 51, four radiation elements 32 or 42, an input impedance-matching circuit 33 or 43, configured such that one end of the antenna is grounded to the short-circuit point 46 of a feed network and the other end thereof is connected to the radiation elements, a feed network 37 or 47, configured to be fed with signals at the bottom of the square, feeding points 44, configured to transmit signals from the feed network to the radiation elements, and a low-noise amplification unit 39 or 49.

Each of the feed networks 37 and 47 feeds signals to the radiation elements 33 or 43 of a corresponding S-QHA at a phase difference of 90 degrees in a clockwise direction or in a counterclockwise direction, and is implemented using Low Temperature Co-fired Ceramic (LTCC) or a multi-layer Printed Circuit Board (PCB).

The square columns 31 and 41 of the S-QHAs may be formed of various media such as air, a dielectric, ceramic and a PCB. The dielectric may have a solid form 41 or a hollow form 31. The hollow form 41 is symmetrical with respect to a vertical line, and may be implemented in various forms. However, the hollow form 41 is not limited to the embodiments that are described herein.

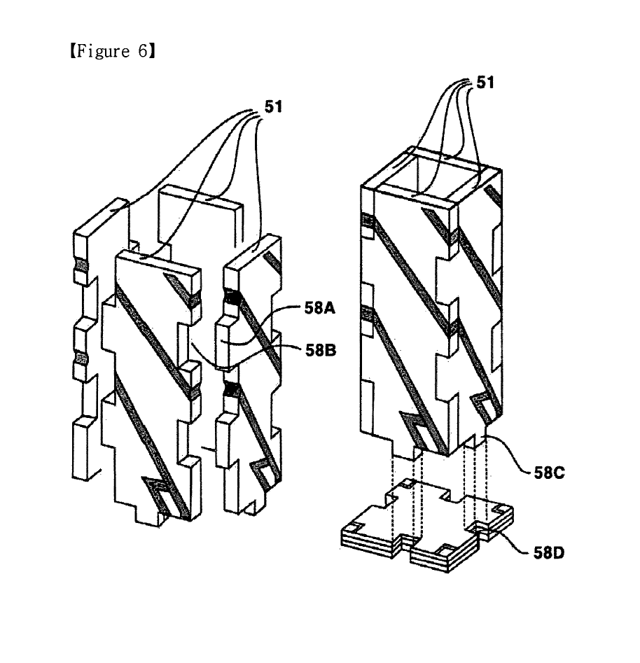

An example of an S-QHA using a PCB board is illustrated as the square column 51 of FIG. 6, and may be implemented using a single-layer board or a multilayer board. Respective square members are coupled to each other through coupling protrusions and recessions 58A and 58B. Furthermore, the square column PCB and the feed network are coupled to each other through coupling protrusions and recessions 58C and 58D. The radiation elements on the coupled portions are electrically connected to relevant radiation elements through soldering.

In order to improve the input impedance of the S-QHAs, branches branch off from each of the radiation elements 32 and 42, and are short-circuited to the short-circuit points 46 of each of the feed networks 37 and 47, thus being electrically connected thereto. The impedance of the antennas varies with the lengths and line widths of the impedance-matching circuits 33 and 43 or the positions of contact with the radiation elements.

According to the present invention, the frequencies of the antennas may be adjusted by changing the lengths or widths of the radiation elements 32 and 42, the widths, heights or permittivity of the square columns 31, 41 and 51, or the hollow structures, or the lengths, widths, or contact positions of the impedance-matching circuits 33 and 43 in the S-QHAs.

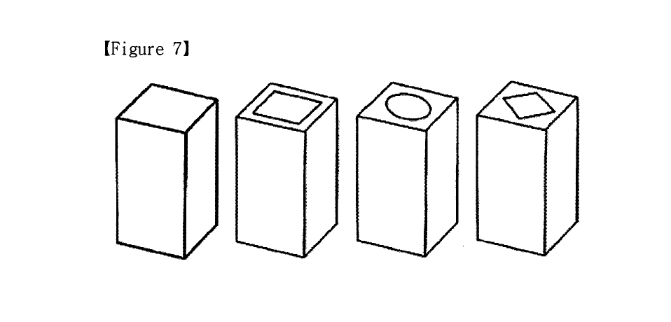

The square columns 31 and 41 of the S-QHAs may be configured to have a square cross-section, and may have a solid or hollow form, as shown in FIG. 7. The hollow form may be symmetrical with respect to a vertical line.

In the antenna modules of the present invention, antenna units and feed networks may be implemented to have various constructions.

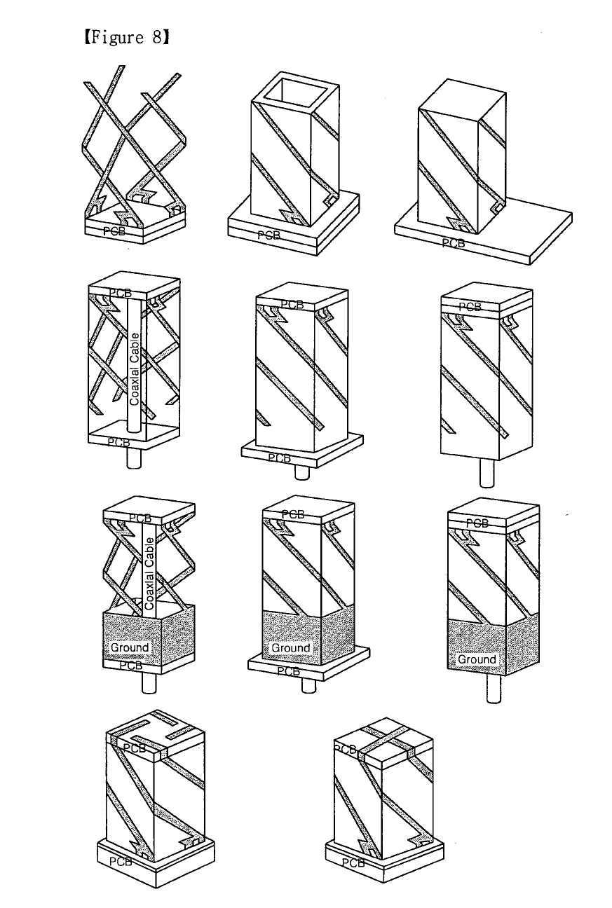

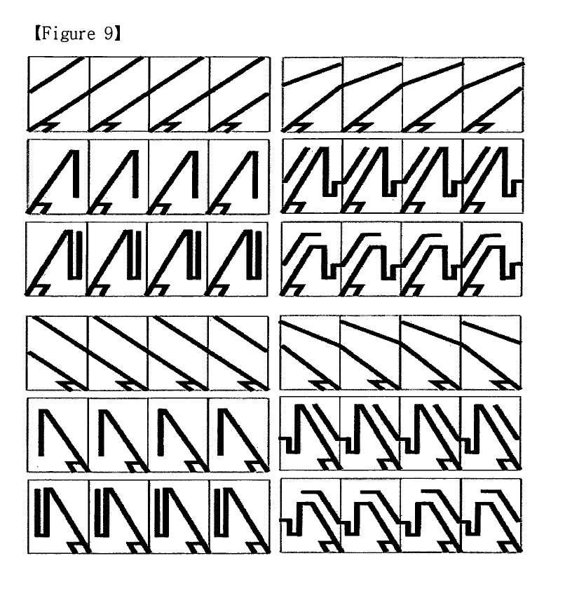

FIG. 8 shows the basic constructions of antenna modules in which antenna units are combined with feed networks, and FIG. 9 shows various examples of the radiation elements 32 and 42, which may be implemented in various forms, such as a rectilinear form, a diagonal form, and a helical form. However, the present invention is not limited to the above-described embodiments.

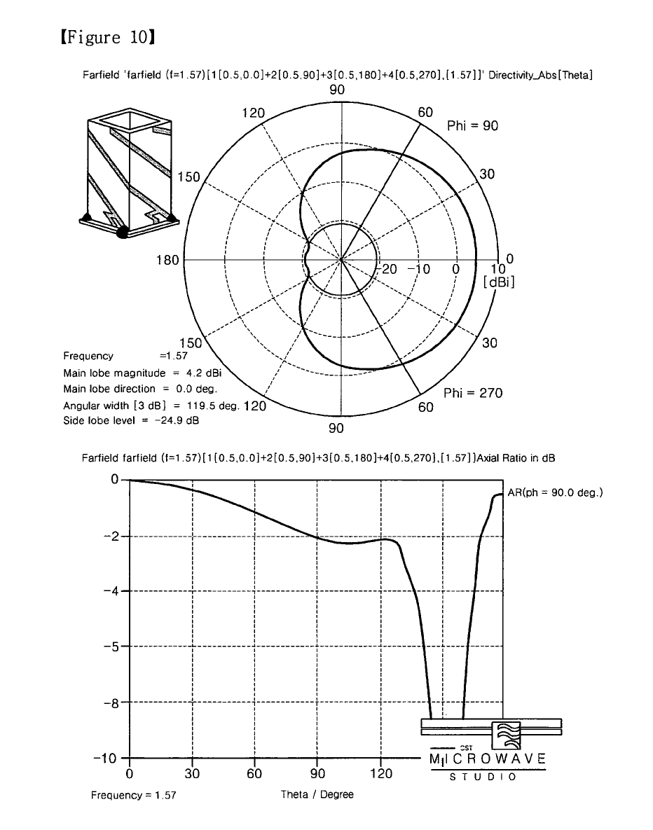

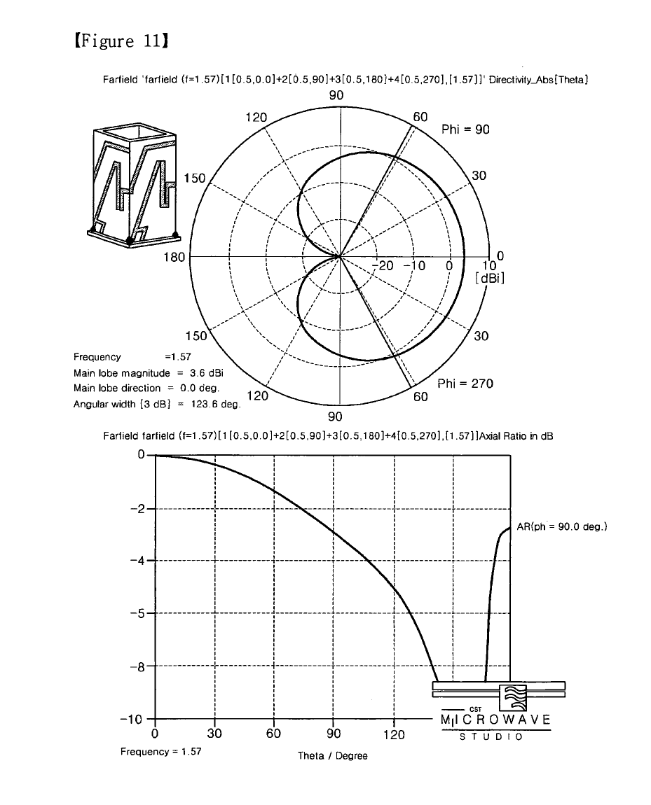

FIGS. 10 and 11 show simulation results for embodiments of the S-QHA, which are proposed by the present invention. FIG. 10 shows an example of the S-QHA having Right Handed Circular Polarization (RHCP) at a center frequency of 1.57 GHz, which was designed using a ceramic board having a permittivity of 9.7. FIG. 11 shows an example of the S-QHA having left handed circular polarization (LHCP) at a center frequency of 1.57 GHz, which was designed using a PCB board having a permittivity of 4.6.

The S-QHA antenna, shown in FIG. 10, has dimensions of 10×10×17.5 mm, a high F/B ratio of 25 dB, a 3 dB beam width of 119.5 degrees, a directivity of 4.2 dBi, and a radiation efficiency of 40%. Furthermore, the 3 dB axial ratio reaches 260 degrees, and the axial ratio at 0 degree at the primary direction has an ideal value of 0 dB.

The S-QHA antenna, shown in FIG. 11, has dimensions of 9.7×9.7×17.5 mm, a high F/B ratio of higher than 30 dB, a 3 dB beam width of 123.6 degrees, a directivity of 3.6 dBi, and a radiation efficiency of 38%. Furthermore, the 3 dB axial ratio reaches 180 degrees, and the axial ratio at 0 degrees in the primary direction has an ideal value of 0 dB.

Although the above description is restricted to the preferred embodiments of the present invention, the present invention is not limited thereto, and the present invention may incorporate various variations, modifications and equivalents. Accordingly, the present invention may use appropriate modifications to the embodiments. It will be apparent that such modifications fall within the range of the rights of the present invention as long as it is based on the technical spirit that is described in the attached claims.

### INDUSTRIAL APPLICABILITY

According to the present invention, helical radiation elements are formed on a square column and an antenna impedance-matching circuit, one end of which is short-circuited to the ground of a feed network and the other end of which is connected to the radiation elements, thereby compensating for the deteriorated radiation pattern, radiation efficiency, axial ratio and antenna gain attributable to a reduction in the size of the antenna.

The above-described structure of the QHA structure according to the present invention is applied to portable terminals for receiving circularly polarized signals, such as a Radio Frequency Identification (RFID) terminal, a Global Positioning System (GPS) terminal, a satellite reception Digital Multimedia Broadcasting (DMB) terminal, an eXtended Modulation (XM) terminal, and a digital satellite radio.

1. A structure of a Square Quadrifilar Helical antenna (S-QHA), comprising:
a square column;
four radiation elements formed on the square column; and
a feed network disposed at a top or bottom of the square column and configured to feed signals to the radiation elements at a phase difference of 90 degrees in a clockwise or counterclockwise direction.

2. The structure of the S-QHA as set forth in claim 1, further comprising a low-noise amplification unit connected to the radiation elements and configured to amplify received signals in a low-noise manner.

3. The structure of the S-QHA as set forth in claim 2, further comprising an impedance-matching circuit, an end of which is grounded to short-circuit points of the feed network and a second end of which is electrically connected to the radiation elements.

4. The structure of the S-QHA as set forth in claim 3, wherein the feed network is formed of a Low Temperature Co-fired Ceramic (LTCC) or a multilayer Printed Circuit Board (PCB).

5. The structure of the S-QHA as set forth in claim 3, wherein the square column uses one or more of air, dielectric, ceramic, and a PCB as media, has a square cross-section, and has a hollow or solid form, the hollow form being symmetrical with respect to a vertical line.
